(19) United States
(12) Patent Application Publication
(10) Pub. No.: US 2002/0007276 A1
(43) Pub. Date: Jan. 17, 2002

(54) Virtual representatives for use as communications tools

(76) Inventors: Michael S. Rosenblatt, Newton, MA (US); Lucille S. Salhany, Dover, MA (US); Richard Guttendorf, Elkton, MD (US); Serge LaFontaine, Lincoln, MA (US)

Correspondence Address: WEINGARTEN, SCHURGIN,, GAGNEBIN & HAYES LLP, Ten Post Office Square, Boston, MA, 02109, US

(21) Appl. No.: 09/847,026

(22) Filed: May 1, 2001

Related U.S. Application Data
(60) Provisional application No. 60/201,239, filed on May 1, 2000.

(51) Int. Cl. G10L 13/08

(52) U.S. Cl. 704/260

(57) ABSTRACT

A system and method for enabling the use of photo-realistic, three-dimensional virtual representatives in a variety of communications settings is disclosed. A first module is employed for selecting a virtual representative to be used for communicating with a user, for defining text to be voiced by the selected virtual representative, and for inserting emotion cues into that text. A second module responds to data from the first module by generating an image of the virtual representative, then controls changes in the image in accordance with the text to be voiced and the corresponding emotion cues. A third module is employed for defining virtual representatives and the response of virtual representatives to emotion cues associated with text to be voiced. The modularity of the presently disclosed invention lends itself to the integration into a variety of settings, including Web pages, email and PC games.

### CROSS REFERENCE TO RELATED APPLICATIONS

This application claims priority to U.S. Provisional Patent Application No. 60/201,239, filed May 1, 2000, incorporated herein by reference.

### STATEMENT REGARDING FEDERALLY SPONSORED RESEARCH OR DEVELOPMENT

N/A

### BACKGROUND OF THE INVENTION

As the World Wide Web (the “Web”) evolves, businesses and content providers are seeking interactive audio, video and other multi-media content as a means to enrich and differentiate their Web sites. So-called “e-tailers” are finding that they must make substantial improvements in their customers' shopping experience to prevent the loss of customers to other sites employing novel shopping experiences. In their effort to turn shoppers into buyers and customers into repeat customers, Web retailers seek ways to improve customer support and the overall quality of the shopping experience.

According to a BizRate.com industry study during the first quarter of 1999, online shoppers rated “customer support” among the weak links of e-commerce sites. Research firm Juniper Communications reported that consumers spent an average of $375 in 1997 and $700 in 1998 online, but that 37% of buyers said that they would spend more if they had access to real-time advice.

Traditional forms of customer support for Web-based retailers include static lists of Frequently Asked Questions (FAQ's), detailed instruction pages, and indexed and searchable help databases. Interactive customer support at its most basic involves the time-consuming exchange of emails, telephone calls, or faxes.

Other forms of electronic communication associated with the advent and growth of the Internet include instant messaging and email. Certain web-sites have implemented real-time, interactive messaging between customers and customer service personnel. While the immediacy of this interactivity is an improvement over the former methods of support, it is still text-based and consequently fails to live up to the standards for proper customer care many consumer associate with so-called “brick and mortar” retailers. It has been proposed to pair such systems with a form of voice-synthesizer, yet realistic visual imagery and cueing, displayable in real-time, are lacking, especially over relatively low-bandwidth connections.

### BRIEF SUMMARY OF THE INVENTION

The present invention is directed toward the development and implementation of photo-realistic, three-dimensional computer animations, also referred to as “virtual representatives,” in a variety of communications settings. These settings include customer-support applications for Web retailers or service providers, as well as interpersonal email and chat. The use of a standard architecture for realization of these virtual representatives and for the modules used to animate them enables the customization of the representatives according to the needs or desires of individual users and the deployment of their use for a variety of business and interpersonal communications applications.

Various levels of control over the appearance and performance of the virtual representatives may be implemented depending upon the application. For instance, a simple version of the presently disclosed invention enables a user to choose one of a selected set of standard virtual representatives, and enables the user to incorporate certain standard expressions into text to be voiced by the selected virtual representative.

More powerful modules of an alternative embodiment of the presently disclosed invention enable the creation of custom virtual representatives, including those based on two-dimensional images, analog or digital, of real people. Standard emotion responses may also be adjusted in this embodiment, and new emotion responses may be created.

The modularity of the presently disclosed invention lends itself to the integration into a variety of settings, including Web pages, email and PC games.

### BRIEF DESCRIPTION OF THE SEVERAL VIEWS OF THE DRAWING

These and other objects of the presently disclosed invention will be more fully understood by reference to the following drawings, of which:

FIG. 1 is a representative screen display generated by an authoring module according to one embodiment of the presently disclosed invention;

FIG. 2 is a representative screen display generated by an application that embodies a player module to include an animated virtual representative in the user interface (UI); and

FIG. 3 is a block diagram illustrating the interrelationship of various modules comprising the presently disclosed invention.

### DETAILED DESCRIPTION OF THE INVENTION

Photo-realistic, two-dimensional or three-dimensional virtual representatives which can be animated in real-time by text or speech files are realized by the presently disclosed invention. Two basic software modules are used to implement the use of these virtual representatives for a variety of applications. These modules are referred to as a an authoring module and a player module The authoring module enables the integration of emotion cues with a message to be voiced by a selected virtual representative. The player module is employed in the generation of the image of the virtual representative at a receiver's location. Once data describing the fundamental characteristics of a particular virtual representative is downloaded, the player is used to receive commands generated from the authoring module which essentially describe adjustments to be made to the displayed image of the virtual representative while the transmitted text or speech data is being voiced by the virtual representative. The player is thus capable of interpreting textual or real voice data to be converted to audible speech synchronized with the appropriate facial movements, as well as responding to the integrated emotion content for further manipulating the virtual representative's image. The authoring module may include both the possibility to use recorded voice and key-framed data for animating the virtual representative on a frame by frame basis or voice and meta-data for animating the virtual representative, where the meta-data contains commands such as “happy” which then gets translated into a happy looking face at the appropriate time.

The authoring module allows also the creation of virtual personalities from the library of emotion and movement packs. For example a “virtual salesman” that incorporates the essential qualities of a competent salesman, such how to focus his attention on a possible client, can be created.

The client/server streaming of the presently disclosed invention conveys, or “streams,” information which controls the rendering of the virtual representative by the player module. Thus, even with a 28.8 Kbps data channel, the presently disclosed player module is capable of reproducing photo-realistic images at an animation rate of 15 frames per second (“fps”) with frame by frame animation or 30 fps with voice-quality sound.

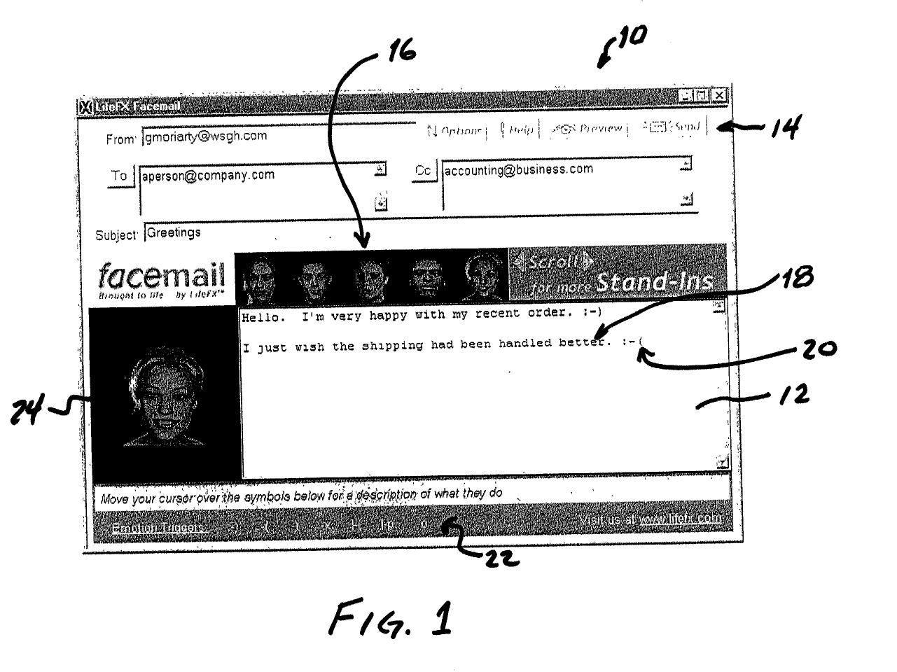

As shown in FIG. 1, the authoring module in one embodiment is implemented as a software application which generates a Graphical User Interface (GUI) 10. A text window 12 is provided on a client PC screen along with selected commands 14 on an associated menu bar or in pull-down menus. Still images 16 of standard virtual representatives, identified as “Stand-Ins” in the figure, are provided.

The text window 12 enables the user to enter and edit text 18 to be voiced by a selected virtual representative and to include basic emotion cues 20 that the selected virtual representative will evoke while conveying the corresponding portion of the transmitted text. Available emotion cues, indicated by so-called “emoticons” 22, are provided. The authoring module is also capable of invoking a player module in order to allow a user to preview the performance of the text with the embedded emotion cues by the selected virtual representative in a separate or integrated window 24.

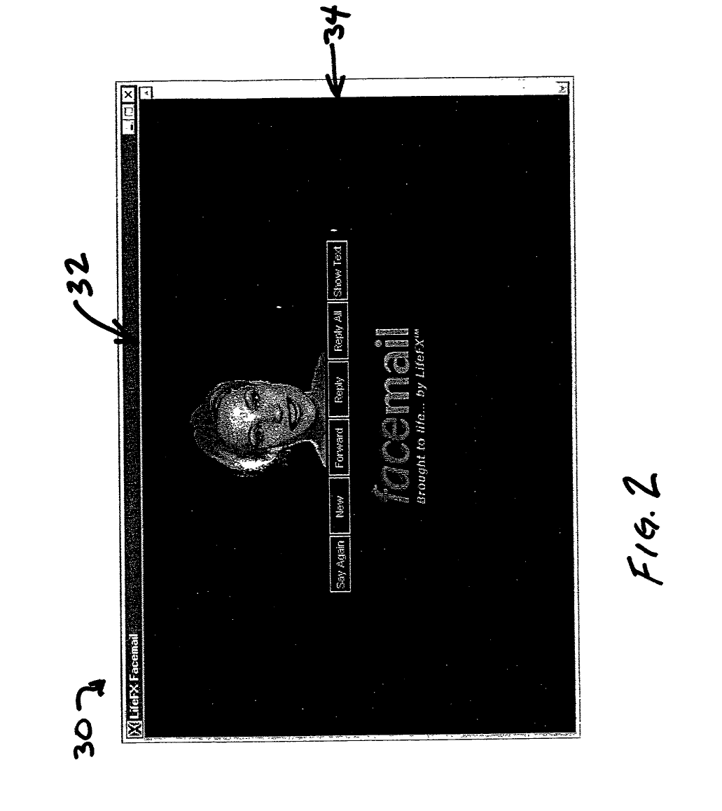

In the illustrated embodiment, the authoring module is configured for generating an email message, an attachment to which includes a media file to be interpreted by a player module as described with respect to FIG. 2. “From:”, “To:”, “Cc:”, and “Subject:” fields are also provided.

In general, the player module is a highly flexible, programmable player that is used for manipulating a fundamental characterization of a selected virtual representative in response to pre-stored or streaming animation commands, such as from a file containing a serialized sequence of commands or from real-time commands created from an authoring tool. The player is modularized such that it may be used and programmed inside a Web browser, used for reading email files, or embedded in applications for performing a variety of system interactions. One embodiment includes a player capable of realizing virtual representatives programmed using either Jscript or Vbscript languages inside Web sites, thus enabling complex, autonomous interactions with a user.

FIG. 2 illustrates a GUI 30 generated by one embodiment of a player module integrated in a client email application. This version of a player module GUI 30 is invoked in response to an email message from a director module, such as that illustrated in FIG. 1. The attachment of that email message contains a media file comprising a representation of the text to be voiced by a selected virtual representative, along with designated emotion cues the emotion pack library. The player module generates an image 32 of the virtual representative selected using the authoring module and modifies this image as the text data is voiced. Embedded emotion cues also effect the image modifications spatially and over time according to the virtual representative. Various controls 34 are provided to the user to control the functionality of the player module.

Another version of the player module in the form a software development kit (SDK) is intended for use as a component to be included in applications such as PC games and other software, as a “computer host” to lead users through new programs and equipment, and for email, long distance learning, screen savers, etc. This integrated player module is responsive to script files which may be realized as serial data files, an indexed database, or other data stores. The script files may be static, or may be modified as desired.

One embodiment of the present invention incorporates a player capable of operating in an ActiveX (Microsoft Corp.) environment. Modularization of the player is facilitated by the use of plural ActiveX or COM components.

A first implementation of such an ActiveX player module developed with the Active Template Library of Microsoft Corp. occupies just 160 Kb of memory. This player module uses the industry-standard OpenGL (Open Graphics Library) Application Programming Interface (API) for graphics and displays a face of substantial complexity. This player module takes advantage of DirectX, an API for creating and managing graphic images and multimedia effects in applications such as games or active Web pages that run under Microsoft Corp.'s Windows 95 (trademark of Microsoft Corp.) operating system. Utilization of an acceleration engine on the client PC is also employed, where available. This implementation of the player module has provided 150 fps on a 450 MHz Pentium II (trademark of Intel Corp.) with a graphics card, and 12 fps on a 266 MHz Pentium II with no graphics card; somewhat slower rates are achieved with texture mapping for rendering of the geometry. Optimized coding of this embodiment is expected to improve these test results.

The modularity of the player module has enabled its implementation into Microsoft Corp.'s Internet Explorer (IE) 4.0, Microsoft Corp.'s Outlook email program and Visual Basic. It has been designed to be operable with any standard Speech API (SAPI) compliant text-to-speech (TTS) engine, though empirical analysis may ultimately result in the identification of one or several particularly well-suited TTS products.

The player includes a master clock which is used to synchronize other activities in the player, such as graphics animation, either when animated without audio sound, or to be synchronized with the audio track when one is included.

While TTS technology will undoubtedly improve over time, many presently available TTS systems are severely restricted in terms of quality of voice, range of voices, intonations, and emotions that can be reproduced. As an alternative, two or three-dimensional virtual representatives generated by the player module according to the presently disclosed invention may be used with true recorded speech. In this instance, a set of algorithms are integrated into authoring module to allow a recorded voice to be mapped dynamically to three-dimensional visemes for accurate lip synchronization. A “phoneme guesser” converts voice into a series of phonemes in time which are then transformed dynamically and in a time varying manner to a set of dynamic visemes. In a second generation a data set including voice and the geometry of mouth postures in time will be acquired and used to develop a “viseme guesser” that will transform directly voice to visemes without going through the intermediate generation of phonemes. Nonlinear System Identification and signal processing may be used for a third generation embodiment instead of standard signal processing techniques, HMM or neural nets in order to directly map voice to modes for three-dimensional viseme generation.

One of the intended applications for the presently disclosed invention is to include virtual representatives in Web sites for the reproduction of captured performances that are streamed and played in real time across the Internet or some other network. Thus, streaming technology is incorporated into the player module in a further embodiment, preferably enabling the transmission and reception of voice and video commands appropriately over a 28.8 Kbps bandwidth connection.

The player can be easily configured for auto-download from a Web engine, as known to one skilled in the art. The player typically works in conjunction with a database of previously captured and edited expressions and phonemes.

A further module which is part of yet another embodiment of the presently disclosed invention is a professional authoring tool intended for more sophisticated users. This module is an advanced tool for controlling the integration of virtual representatives into Web sites and email programs, and to create media files which are essentially scripts including text or recorded speech to be spoken and associated emotion or movement cues. The creator module provides integrated programming code for the production of these media files to be included in Web sites or documents which support Web browser commands.

In one version of a professional authoring tool, a first subset of pre-defined emotion cues are provided, while further emotion or expression cues are made available for subsequent integration into the authoring module. These further cues may be available to a user for free, under license, or for outright sale.

One particular embodiment of the professional authoring tool is provided with a graphical user interface (not illustrated) including windows where virtual representatives appear and pop-up windows for specifying emotions, speech rate, head rotations and movements, mouth postures and other facial contortions. A time-line is provided with graphical representations of where emotion cues start and stop, and a graphical editor to delete, move or cut, and paste part of a series of responses or “a performance.” In a further embodiment of the professional authoring tool a video-camera is used to capture in real-time facial features that are subsequently mapped to the virtual representative's face for controlling its emotions and expressions. In yet another embodiment an MPEG4 facial animation stream is used and re-mapped to animate the virtual representative's face.

An advanced version of the professional authoring module enables control over the position, lighting, expressions, emotions, and movement of the virtual representatives and how these factors interact.

The authoring module is partially comprised of a mode generation module, the basic building block required to reproduce dynamic animations of faces on a client PC. It provides very high compression rates for streamed graphics, node blending for blending expressions, and three-dimensional animation and lip-synch to phonemes (i.e. visemes). A further embodiment of the mode generation module implements physiologically-based animations of emotions based upon higher commands simulating neurophysiological commands to face muscles.

The presently disclosed system is particularly applicable to the generation of three-dimensional representations of a human head for the delivery of previously recorded text or speech along with desired emotional responses. Further embodiments are applicable to the generation of entire bodies or portions thereof, including the higher neuro-muscular activation of muscle groups responsible for expressions or motion. Further, the principles of the present invention are also applicable to the generation at a client platform of any three-dimensional object having defined response characteristics with regard to speech, sound, emotions, etc.

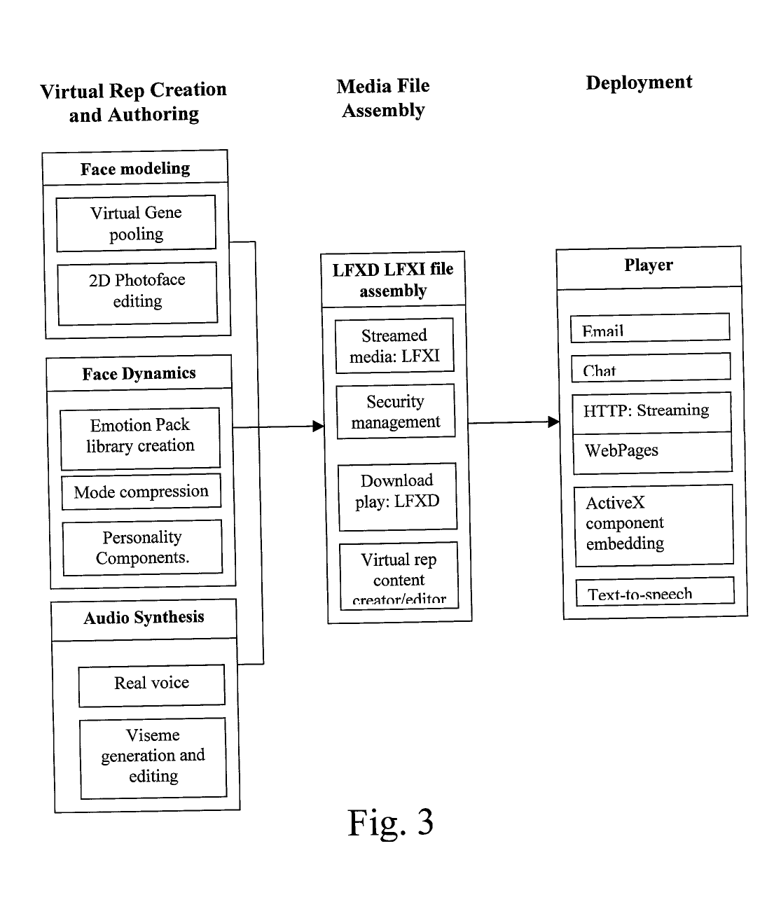

The elements of a first embodiment of a complete system for the generation and display of virtual-representative-voiced messages is illustrated in FIG. 3. A dynamic data capture system is used to acquire dynamics of three-dimensional shape changes and mechanical properties of a flexible and deformable object such as a face in order to create a virtual gene pool of dynamic data sets and other static geometrical and fix information about a face. A finite element system and mapping algorithms can map an appropriate dynamic data set or elements of a dynamic data set between virtual representatives. An authoring module, through a GUI, provides a set of pre-defined virtual representatives in a virtual representative library and a text editor or sound recorder for generating the message to be voiced and for inserting emotion cues into the text string. The emotion cues are taken from an associated set of cues stored in an emotion library. A player module is provided in conjunction with the director module to preview of the constructed message prior sending it to the intended recipient. The assembled virtual representative selection, message text, and associated emotion cues are stored in a media file.

Once prepared, the media file is streamed to the player module, such as through email, direct network connection, or via media file storage. The player module analyzes the received data to identify the selected virtual representative, to parse out the text to be voiced by the TTS engine, for viseme generation based upon that text, and to identify the embedded emotion cues. A GUI, as shown in FIG. 2, is provided for controlling the message replay.

The preferred generation of three-dimensional virtual representatives according to the present invention is based upon continuum modeling techniques, which are mathematical tools developed to represent material properties of solids, including tissues . Large complex structures are broken down into smaller components with geometrical shapes described by nodes and surfaces. In one embodiment, a human face is modeled using 500 nodes and rendered using 20,000 polygons. Movement and animation of a human face model is achieved by applying a set of constitutive mathematical equations that replicate properties associated with biological tissues. For example the shape of lips can be computed at any arbitrary point on the lips even though the movement of that point is not directly recorded in time.

In order to generate virtual representatives having realistic response characteristics, a computer model of a performer's face is created using an optical scanning system such as the Cyberscan laser-scanning system developed by CyberOptics Corporation. Still photographs are then used to acquire various textures. A “performance” is then acquired using a proprietary data motion capture system in real time, followed by video digitization and tracking analysis using the modeling techniques described above. A series of node coordinates are then generated that track material features as they move in time. This results in acquiring even the most subtle change in facial geometry as the performer goes through a series of motions and expressions. Details such as tongue and eye movements may subsequently be verified and retouched by manual intervention.

Thus, the presently disclosed invention provides a standard platform for a network that facilitates the use of three-dimensional, photo-realistic virtual representatives for use as guides, corporate spokespersons, teachers, entertainers, game characters, personal avatars, advertising personalities, and individual sales help. Applications for these virtual representatives include email, Web pages, instant messaging, chatrooms, training, product support, human resources, supply chain software, ISP's, ASP's, distance learning, bill presentment, and PC gaming, among others.

One service which utilizes the virtual representatives of the present disclosure involves the customization of virtual representatives based upon images of end-users. A consumer provides a two-dimensional representation of themselves, in analog or digital format, which is used to customize a standard virtual representative model. Submission is by a variety of means, including electronic submission to a Web site via email or manual delivery via mail carrier.

Once an end-user's photograph has been scanned, software is employed for recognizing facial features such as the face outline, hairline, jaw, ears, eye location and contours, eyebrows, lips, nose, etc. The graphical interface provided by the creator module described above is then optionally used to refine the results of the software recognition.

Next, the presently disclosed system fits data points of a standard or “generic” virtual representative to those generated from the end user image using data from the virtual gene pool. Through a process of facial database matching, optimization, and morphing, the appropriate three-dimensional geometry for the user-submitted image is created.

The data file representing the customized model is then returned to the consumer for installation on the client PC and for distribution to friends and others with whom the consumer uses the present system for correspondence. By this process, user-customized virtual representatives are marketable to the public.

Data security constitutes a crucial element of the implementation of the animation files and the player. Thus it is impossible to create a new animation from a face unless this is permitted by the entity owning the rights to such a face. One application of this security feature is useful in the instance where a standard authoring module is distributed having a first set of virtual representatives available for use. Other “premium” virtual representative definitions are provided, but locked and potentially hidden from the user. These premium definitions can be made available through the purchase of a virtual key or by some other form of subscription.

These and other examples of the invention illustrated above are intended by way of example and the actual scope of the invention is to be limited solely by the scope and spirit of the following claims.

What is claimed is:

1. A system for the use of virtual representatives for message communication, comprising:
a director module for defining information to be communicated by a virtual representative and for transmitting the information; and
a player module for receiving the transmitted information, for generating the virtual representative based upon data characterizing the appearance of the virtual representative and for modifying the appearance of the virtual representative based upon the transmitted information.

2. The system of claim 1, wherein the director module partially comprises a player module.

3. The system of claim 1, wherein the director module and the player module are each embodied as software programs executable on a computer.

4. The system of claim 3, wherein the data characterizing the appearance of the virtual representative is stored in memory associated with a computer executing the player module.

5. The system of claim 1, wherein the information to be communicated by a virtual representative comprises text to be voiced by the virtual representative.

6. The system of claim 1, wherein the information to be communicated by a virtual representative comprises emotions to be evoked by the virtual representative.
